(19) United States
(12) Patent Application Publication
(10) Pub. No.: US 2004/0013883 A1
(43) Pub. Date: Jan. 22, 2004

(54) Waterproof breathable layered article with high mechanical strength

(76) Inventor: Mario Polegato Moretti, Crocetta Del Montello (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/399,396

(22) PCT Filed: Oct. 12, 2001
(86) PCT No.: PCT/EP01/11835

(51) Int. Cl. B32B 27/00

(52) U.S. Cl. 428/422.8; 428/480

(57) ABSTRACT

A waterproof breathable layered article having high-level mechanical strenght characteristics which comprises at least one membrane made of hydrophilic polymer coupled to a support which is permeable to water and comprises fibers of materials which are technologically per se known as composites.

### TECHNICAL FIELD

The present invention relates to a waterproof breathable layered article.

### BACKGROUND ART

Waterproof breathable layered articles are already known, particularly in the field of clothing and shoes, which are constituted in practice by a membrane based on expanded polytetrafluoroethylene, microporous and/or hydrophilic polyurethane coupled by lamination to a supporting mesh made of plastics.

The membrane is in fact inherently unable to support itself, since in practice it is constituted by a very thin film.

Applications that use breathable waterproof membranes are disclosed in several patents by the same Assignee related to waterproof breathable soles for shoes.

By way of example, U.S. Pat. No. 5,044,096 and EP-0382904, hereby incorporated by reference, disclose a sole constituted by:

a lower part made of rubber or synthetic material with through microperforations,

a membrane made of breathable and waterproof microporous material, which covers the lower part,

an upper part, preferably made of rubber or other synthetic material, which is assembled to the lower part and has through holes.

In practical execution, the membrane and the upper part can constitute the layered element mentioned in the introduction, which is joined hermetically and perimetrically to the lower part.

Although the sole having the above described features has been commercially available for years and is unanimously acknowledged to be capable of ensuring correct exchange of heat and water vapor between the microclimate inside the shoe and the external one, said sole has been found to have drawbacks, including in particular the tendency of the membrane to tear due to its different elongation with respect to the lower part (tread) with which it is assembled monolithically at its peripheral region.

The membrane used is made of expanded polytetrafluoroethylene.

This is a poorly elastic material, whereas the sole must be very elastic and flexible by its own nature and in view of its application requirements.

The supporting mesh that is used is characterized by a reduced resistance to traction (breaking stress of approximately 150 N and ultimate elongation of approximately 50%) and therefore does not assist the membrane very much.

Therefore, the membrane is unable to absorb the stresses induced therein by the flexural deformations of the sole in movements during use and accordingly tends to tear and lose its waterproof properties.

Normally, a protective element, usually made of polyester felt, is placed below the membrane, but it has been found unable, on its own, to absorb the tensions induced by the deformations of the sole.

Polyurethane membranes are not used due to their poor mechanical characteristics (ultimate elongation approximately 50%, breaking stress approximately 150 N).

### DISCLOSURE OF THE INVENTION

The aim of the present invention is to provide a waterproof breathable layered article that can replace those currently comprising polytetrafluoroethylene membranes and is characterized by better mechanical strength characteristics, particularly by low elongation and high breaking stress.

Within this aim, an object of the present invention is to provide a layered element that is capable of withstanding greater stresses than those usually generated in particular in applications on shoes.

Another object is to provide a layered element with waterproof and breathable characteristics that are at least equal to those of articles of the same type already in use.

This aim and these and other objects which will become better apparent hereinafter are achieved by a waterproof breathable layered article, comprising at least one membrane made of hydrophilic polymer, characterized in that said membrane is coupled to a substrate which is permeable to water and comprises fibers for materials which are technologically per se known as composites.

Further characteristics and advantages of the invention will become better apparent from the description of a preferred embodiment thereof, given only by way of non-limitative example hereinafter.

### WAYS OF CARRYING OUT THE INVENTION

Particular polymers, for example polyurethanes based on polyether and/or polyester, are known which are characterized by marked hydrophilic characteristics produced by (temporary or stable) dipoles that are present is along the molecule chain.

These materials are fluid before they polymerize and are therefore suitable to be spread on temporary process substrates or on final substrates which comprise fibers for materials technologically per se known as composite, particularly with an ultimate elongation of substantially 5% or less and a breaking stress of substantially 1000 N or more.

Said polymers can resume the fluid state by dissolving them in suitable solvents.

After polymerization or elimination of the solvent by drying, the membrane obtained by spreading (with a thickness in the order of one tenth of a millimeter) is inherently able to withstand elastically a considerable ultimate elongation (greater than 50%) and has a breaking stress comparable to that of known polytetrafluoroethylene membranes.

In order to achieve the above mechanical characteristics, the substrate can also be formed by substrates made of fibers of carbon and/or glass and/or polypropylene and/or polyester woven with various orientations: weft, warp, oblique.

This is done to conveniently ensure optimum resistance to deformation in all directions, although it is possible to consider efficient the longitudinal and transverse directions.

The substrate can assume the form of a lattice constituted by bands of woven and impregnated fibers, which leave wide gaps for air passage.

The fibers of the substrate can be impregnated with appropriately provided resins, such as phenolic resins, polyurethane resins, epoxy resins, natural or synthetic rubbers which are designed to transmit the load to the entire set of fibers.

As an alternative, the polymer that constitutes the membrane can also act as an impregnating agent.

Impregnation must be performed so as to avoid creating a compact layer, in order to avoid compromising breathability.

For this purpose, it is possible to provide through holes in the substrate.

As an alternative, it is possible to provide the substrate by means of fibers having characteristics similar to those described above but having a low melting point, so that by means of a hot-pressing process it is possible to melt part of them so as to monolithically couple them by melting, producing impregnation in this manner.

As an alternative, the substrate can be constituted by a set of fibers of the types described above, embedded in the mass of the polymer in a random arrangement and in such an amount as to form a composite in which the polymer constitutes simultaneously both the matrix for mutually connecting the fibers and the waterproof and breathable membrane.

The layered article is conveniently produced with a thickness in the order of 1-3 mm.

Once spreading has been performed at ambient temperature, the long-fiber substrate is coupled to the spread material before it polymerizes, i.e., before it becomes solid.

The assembly must then be polymerized, and this transformation can be induced by heating (in the order of 30-40° C.) and/or application of radiation having a suitable wavelength (for example ultraviolet rays) and/or variation in the humidity of the ambient air.

In this manner, the long-fiber structure is completely or partially immersed in the polymer mass.

Polymerization can even be induced by the presence of atmospheric dust and/or moisture.

In the case of permanent coupling to a substrate, the end result is a layered article that comprises at least one permeable and breathable membrane that is spread, and therefore intimately coupled, on at least one surface of a substrate made of permeable material.

From the industrial production standpoint, it is possible to provide for direct continuous application of the fluid polyurethane, by means of a feeder provided with a doctor blade, onto the substrate which advances continuously (for example by means of a moving belt) and subsequent insertion in an oven.

In an alternative case, the liquid polyurethane can be applied by means of a feeder provided with a doctor blade on a temporary surface (release paper), starting the polymerization step so that the membrane assumes a certain consistency but is still able to bond to a long-fiber textile substrate and perform coupling to said substrate.

In another case, the membrane can be provided separately and then coupled to the substrate (on one or both surfaces thereof) by joining to a layer constituted by the same constituent of the membrane.

In another alternative, it is possible to provide for impregnation of the substrate with the polyurethane.

In practice it has been found that the intended aim and objects of the present invention have been achieved.

A waterproof breathable layered article has in fact been devised which is capable of replacing those that currently comprise polytetrafluoroethylene membranes, since it achieves by higher mechanical strength characteristics, particularly a lower elongation and a higher breaking stress.

The layered article in fact combines the membrane made of hydrophilic polymer, such as polyurethane based on polyether and/or polyester, which is highly elastic (ultimate elongation can be estimated at 50%) with a substrate which has elongation values of less than 5% and breaking stress of more than 1000 N.

The layered article is therefore capable of withstanding stresses that are higher than those usually occurring in particular in applications on shoes.

The article further has waterproofing and breathability characteristics that are at least equal to those of articles of the same type that are already in use.

The invention thus conceived is susceptible of numerous modifications and variations, all of which are within the scope of the inventive concept.

In practice, the materials used, so long as they are compatible with the contingent use, as well as the dimensions, may be any according to requirements.

The disclosures in Italian Patent Application No. PD2000A000244 from which this application claims priority are incorporated herein by reference.

1. A waterproof breathable layered article, comprising:
at least one membrane made of hydrophilic polymer; and
a support, to which said membrane is coupled, and which is permeable to water and comprises fibers for materials which are technologically per se known as composites, and which has an ultimate elongation of substantially 5% or less and a breaking load of substantially 1000 N or more.

2. The layered article according to claim 1, characterized in that said hydrophilic polymer is polyurethane based on polyether and/or polyester.

3. The layered article according to claim 1, characterized in that said substrate is formed by layers made of fibers of carbon and/or glass and/or polypropylene and/or polyester woven with different orientations: weft, warp, oblique.

4. The layered article according to claim 1, characterized in that said substrate has the form of a lattice constituted by bands of woven and impregnated fibers which leave air passage spaces.

5. The layered article according to one or more of the preceding claims, characterized in that the fibers of the substrate are impregnated with resins such as phenolic resins, polyurethane resins, epoxy resins, natural or synthetic rubbers which are designed to transmit the load to the entire set of fibers, impregnation being such as to avoid creating a compact layer in order to avoid compromising breathability.

6. The layered article according to one or more of claims 1 to 4, characterized in that said substrate is made of fibers melted by a hot pressing process for carrying out bonding thereof by melting and impregnation.

7. The layered article according to one or more of claims 1 to 4, characterized in that said substrate is constituted by a set of fibers at least partially embedded in the mass of polymer with a random arrangement and in such an amount as to form a composite in which the polymer constitutes simultaneously the matrix for mutually connecting the fibers and the waterproof breathable membrane.

8. A method for manufacturing a layered article according to one or more of claims, which consists in:
directly and continuously applying the fluid polymer to the substrate, and
starting polymerization.

9. A method for manufacturing a layered article according to one or more of claims 1 to 7, consisting in:
applying the fluid polymer by means of a feeder on a temporary surface,
starting the polymerization step so that the membrane assumes a certain consistency, and
coupling to the substrate by completing the polymerization.

10. The method for producing a layered article according to one or more of claims 1 to 7, consisting in:
producing the membrane separately, and
coupling it to the substrate by joining with a layer constituted by the same polymer that constitutes the membrane.

11. The method for manufacturing a layered article according to one or more of claims 1 to 7, consisting in impregnating the polymer with the substrate.
